(19) United States
(12) Patent Application Publication
(10) Pub. No.: US 2015/0360738 A1
(43) Pub. Date: Dec. 17, 2015

(54) Method of Customizing Automotive Interior

(71) Applicant: Spintek Filtration, Inc., Los Alamitos, CA (US)

(72) Inventors: William A. Greene, Long Beach, CA (US); Jason D. Gilmour, Fountain Valley, CA (US)

(21) Appl. No.: 14/301,828

(22) Filed: Jun. 11, 2014

(51) Int. Cl. B62D 65/14

(52) U.S. Cl. CPC B62D 65/14

(57) ABSTRACT

A method of designing or retrofitting a passenger compartment of a motor vehicle. The method includes the steps of (1) selecting interior components for removably installing in the passenger compartment of the motor vehicle; (2) removing old interior components from the passenger compartment of the motor vehicle; and (3) removably installing new interior components into the passenger compartment of the motor vehicle. The method provides a means of quickly and easily changing or enhancing the aesthetical look of the passenger compartment of the motor vehicle.

### FIELD OF THE INVENTION

The present invention relates generally to methods of providing a customized automotive interior in a quick and easy manner.

### BACKGROUND OF THE INVENTION

Many consumers, whether of high end (luxury) automobiles or otherwise, desire to change or modify the interior and/or exterior of their vehicle in order to customize it and make it their own. Thus, there exists a vast aftermarket for building and/or retrofitting customized automobiles. However, for some consumers, there is an additional desire not just to customize the vehicle but also to change the interior of the vehicle, whether it be for a special occasion, for a change of season (i.e., summer to winter or vice versa), or simply because the consumer no longer likes the look of the existing interior.

For example, as described in U.S. Pat. Pub. No. 2013/0093225 to Janowski, the subject matter of which is herein incorporated by reference in its entirety, a common customization for cars is the installation of aftermarket seat covers to alter the appearance of the vehicle, such as by matching an aftermarket paint job or by matching other decorative items added to the vehicle. Janowski describes automobile seat covers which have removable and replaceable panels which may be interchanged to quickly and effectively alter the visual appearance and functionality of the seat.

However, Janowski is limited to the customization of seat covers and it would also be desirable to provide additional customizable components for the automotive interior for altering the appearance of the passenger compartment of the automobile in a quick and efficient manner so that the consumer can easily change the look and feel of the interior. That, is while there are many options available to the consumer for customizing their automobile's interior, these options tend to be very time consuming and expensive. In addition, the automobile may have to remain in the shop for an extended period of time to complete the customization, leaving the consumer without access to their vehicle. Thus, it is highly unlikely that a consumer would change or customize the interior of their vehicle on a routine basis due to the time commitment and the cost involved.

U.S. Pat. No. 6,695,380 to Hicks, the subject matter of which is herein incorporated by reference in its entirety, describes a vehicle floor panel for attachment to the floor pan of an automotive vehicle, especially for use in the cargo area of the vehicle. The floor panel is a reversible floor board in which the first surface has a fabric covering attached thereon and the second surface has at least one mounting device integrated thereon for securing an item to the floor panel. The floor panel also has at least one fastener for selectively coupling the panel to the floor pan to permit access to either the first surface or the second surface of the floor panel. However, it appears that Hicks is only concerned with the serviceability of securing items to the floor panel of the automobile and does not contemplate the ability to change the look of the floor panel, depending on the needs and desires of the consumer.

U.S. Pat. No. 7,036,848 to Chemoff et al., the subject matter of which is herein incorporated by reference in its entirety, describes a vehicle body configuration having a self-contained chassis design with interchangeable bodies. Chemoff suggests the use of one chassis upon which a multitude of body styles may be mounted. However, Chemoff does not recognize that an automotive consumer may wish to modify or change the interior of the passenger compartment of the automobile, in order to, for example, change the color or the look of one or more of the door panels, ceiling panels, door panels, etc. in order to change or modify the “look” of the passenger compartment.

Likewise, U.S. Pat. Pub. No. 2011/0215199 to Lee, the subject matter of which is herein incorporated by reference in its entirety, describes panel inserts for aircraft that can be easily changed as well as components on the aircraft that are specifically designed to receive and cooperate with the panel inserts. Lee describes that these panel inserts are designed for use in aircraft galleys.

GB 2,143,000 to Mallinson-Denny, Ltd. describes modular panel assembly that will allow a damaged part of a vehicle wall or floor of a goods vehicle to be removed and replaced. The modular panel assembly comprises a plurality of planar rectilinear sheet panel members that are bolted together. However, the modular panel assembly is not capable of being removed or replaced without special tools and is also not concerned with the aesthetic look of the panel assembly.

Thus, there remains a need in the art for an improved means of customizing and/or changing the interior of an automobile in a quick and efficient manner. In addition, there remains a need in the art for an improved means of customizing and/or change the interior of the automobile to create a customized passenger compartment that may be changed and updated as the consumer desires. There also remains a need in the art to provide an improved means of removing and replacing damaged panels to improve the aesthetic look of the passenger compartment.

### SUMMARY OF THE INVENTION

It is an object of the present invention to provide a means of changing out various features of the interior of an automobile or other vehicle.

It is another object of the present invention to provide a means of changing out various features of the interior of the automobile that can be done quickly and easily.

It is another object of the present invention to provide an improved means of changing the look of the interior of the automobile, including the floor, door panels, instrument panels, ceiling and seats.

It is still another object of the present invention to provide an improved means of removing and replacing seats in an automobile to improve the aesthetic look of the automobile.

It is still another object of the present invention to provide an improved means of removing and replacing these seats so that the seats are secured to the vehicle while at the same time being easily removable and replaceable.

It is still another object of the present invention to provide a means of removing and replacing seats in an automobile while providing electrical contacts to control heating, cooling and/or movement of the replacement seat.

It is still another object of the present invention to provide a means of changing the interior of an automobile that is customizable.

It is yet another object of the present invention to provide a means of changing the interior of an automobile using modular pieces.

It is yet another object of the present invention to provide a means of changing the interior door panels, wall panels, trim panels, ceiling panels, floor panels, etc. of an automobile in which the panels are flippable and/or reversible.

To that end, in one embodiment, the present invention relates generally to a method of removably designing or retrofitting a passenger compartment of a motor vehicle, the method comprising the steps of:

a) selecting interior components for removably retrofitting the passenger compartment of the motor vehicle;

b) removing then currently installed interior components from the passenger compartment of the motor vehicle; and

c) removably installing alternate interior components into the passenger compartment of the motor vehicle;

whereby an aesthetical look of the passenger compartment of the motor vehicle is changed or enhanced.

### BRIEF DESCRIPTION OF THE DRAWINGS

FIG. 1 depicts a flow chart demonstrating a method of selecting and installing interior components in accordance with one embodiment of the invention.

### DETAILED DESCRIPTION OF THE PREFERRED EMBODIMENTS

As described herein, in one embodiment, the present invention relates generally to a method of designing or retrofitting a passenger compartment of a motor vehicle, the method comprising the steps of:

a) selecting interior components for removably installing in the passenger compartment of the motor vehicle;

b) removing then currently installed selected interior components from the passenger compartment of the motor vehicle; and
c) removably installing alternate interior components into the passenger compartment of the motor vehicle;

whereby an aesthetical look of the passenger compartment of the motor vehicle is changed.

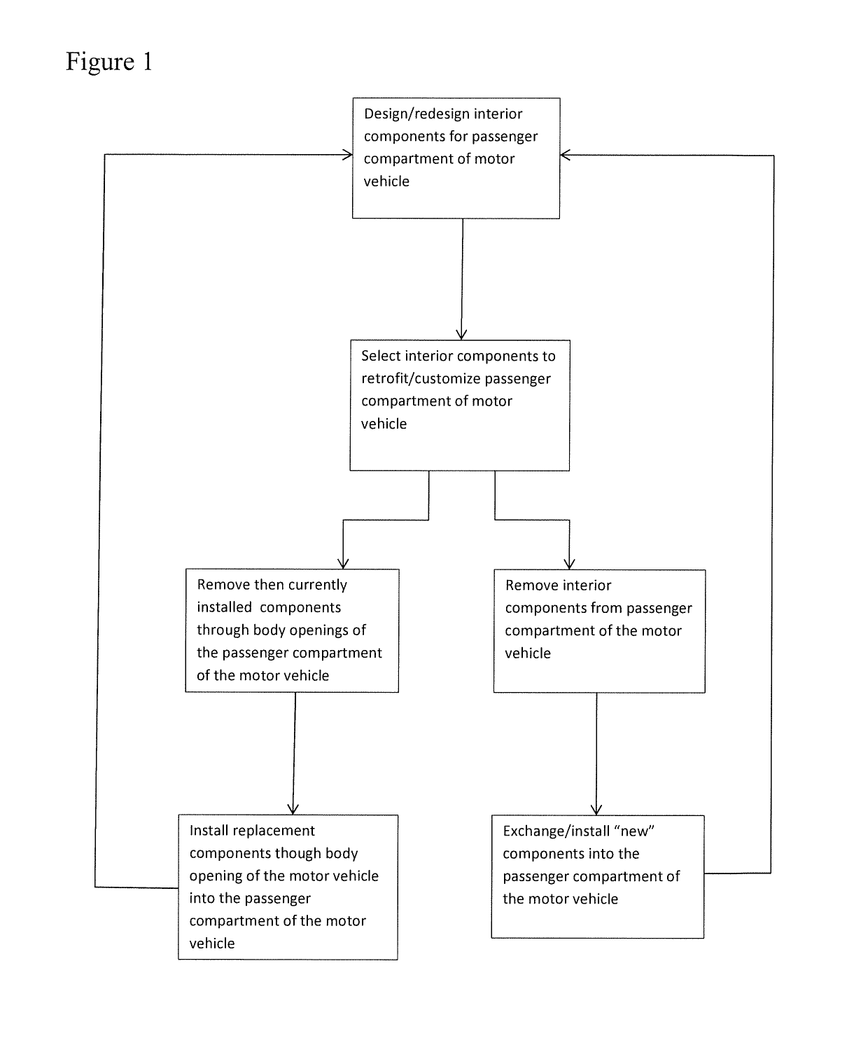

As depicted in FIG. 1, the consumer may select interior components “off-the shelf” for which they desire to retrofit or customize at least the passenger compartment of their automobile. These interior components include, but are not limited to panels, including door panels, interior wall panels, trim panels, ceiling panels, floor panels and the like, seat covers, seats (both front and rear), instrument panels, dash board etc.

The interior components would be produced for various years/makes/models of automobiles, and a consumer would select interior components for their particular year/make/model having the aesthetic look they desire. In addition, in a preferred embodiment, the interior components are designed so that they may be quickly and easily removably installed in and removed from the automobile. This can be accomplished with removable attachment means such as snaps, rubber grommets and corresponding male attachment means, VELCRO®, magnetic attachment means, corresponding grooves or channels, J-lock system, or temporary adhesive. Thereafter, if the consumer wishes to change the interior components to achieve a different look, they may select additional alternate interior components and swap out the then currently installed components to achieve the new look. It is further contemplated that interior components may be continuously designed and redesigned to provide a variety of new and updated looks for the particular year/make/model for the consumer to choose from. Specifically the interior components can be designed to reflect changing style preferences, fads, or new fashion designs.

In one embodiment, these interior components may be fabricated, so that the consumer simply chooses his/her desired components from one of any number of “off-the-shelf” interior components. In this instance, it is contemplated that the interior components would be designed by a designer of automotive interiors to achieve a certain look, including, for example, color, texture, material, durability, etc. and that the interior components would be continuously updated so that “fresh” new interior components are continuously available to the consumer as they desire to update their vehicle.

In another embodiment of the present invention, the consumer may wish to design their own unique interior components so as to create a completely unique look for their vehicle. Thus, the consumer may work with a designer to create a custom look. The designer may have various templates for the year/make/model of vehicles that the consumer would find desirable to customize. Once the designer (and/or the consumer) chooses the desired look for the passenger compartment of the automobile, the interior components may be fabricated to the consumer's specifications and for the particular year/make/model of their vehicle. The interchangeable panels may be coupled with a lighting system in the passenger compartment which is capable of changing the color and tone of the lighting to match or complement the new interior look. This changeable lighting system may employ fiber optics to transmit the desired color and tone of light to various points within the passenger compartment.

Once the various interior components have been chosen and are available, the then currently installed (“old”) interior components may be removed from the passenger compartment of the vehicle and the “new” or alternate interior components installed therein. The “old” components are typically removed through the body openings of the passenger compartment.

In one embodiment, the interior component may be a panel, such as a door panel, interior wall panel, trim panel, ceiling panel, floor panel or the like. These panels are designed to be both replaceable and interchangeable. The use of such replaceable and interchangeable panels helps to enhance the aesthetic look and feel of the passenger compartment of the motor vehicle. In other words, the aesthetic look of the passenger compartment may be modified or enhanced to suit the consumer. Depending on the size of the area to be customized, (i.e., ceiling or large door), one or more panels may be joined together in a modular fashion.

In addition, if a panel becomes damaged or marred, the invention described herein provides a novel method of swapping out the “old” panel for a fresh, new panel. The panels may be removed, replaced and interchanged easily and without specific tools and without damage to the panel. Additionally, the “old” panel may be removed and updated with new paint, fabric, materials, etc. and then reused within the vehicle to get a new look.

The panels described herein may feature imprinted graphics, indicia, decorative elements, artwork and other design elements that a consumer wishes to include thereon. Thus, the panels may include one or more patterns, pictures, logos, photos, designs symbol or any other visual indicia to be displayed on the panel. In one embodiment, one or more panels may be used together to create a unified look. Thus, in the case of the door panels or the ceiling panels, one or more panels may be interlocked together to create a continuous pattern, picture, logo, etc.

The panels may have various finishes including, for example, a stainless steel finish, a glossy or matte color finish, a fabric-type material, a wood-like or wood finish, laminate, vinyl, leather (real or synthetic), metals (e.g., aluminum or steel), plastics (e.g., polycarbonate), metallic glass, mirror-type or reflective finish, a lenticular image or any other finish that the consumer desires to include in the passenger compartment of the automobile. Furthermore, in the case of fabrics and other soft materials, the panels may comprise an interior material having sufficient rigidity and that is suitable for use in automotive interiors, which is then covered with the soft material.

In addition, in the case of the floor panels, the consumer may wish to select materials that are durable, including materials such as wood, wood veneer, laminate, metals (patterned or otherwise), plastics, carpet, etc.

It is also desirable that the panels are easily removable and replaceable without damage to the panels so that the panels may be reused/reconfigured for other uses and without any damage to either the panels or the frame of the vehicle. This design can either be retrofitted into an existing automobile or designed into an automobile from its original construction. In either case, the interior components must be designed so that they are removably attached to the body of the automobile with fasteners that are easily detached such as snaps, rubber grommets and corresponding male attachments, VELCRO®, magnetic attachment means, corresponding grooves or channels, J-lock system, or temporary adhesive. The key is that the interior components are easily removable without damaging the automobile and without need for special tools or skill.

In one preferred embodiment the panels (whether door, ceiling or floor) are flippable so as to provide additional options to the consumer. For example, the consumer may wish to switch back and forth between a light and dark interior or to have a more “formal” interior that is only used on special occasions. The consumer may also wish to switch between a more “utilitarian” and a more conventional look. In addition, the use of flippable panels allows the consumer to switch interiors if the interior starts to look worn or dated. As is readily seen, the use of the flippable panels allows the consumer to easily customize the interior of their vehicle in a quick manner. The flappable panels should have attachment means which easily line up with and correspond to the attachment means on the automobile body no matter which side of the flappable panel is showing. Thus, in contrast to the prior art in which the consumer would need to return to a custom shop multiple times in order to change the interior, the present invention allows the consumer to quickly and easily change the look of their vehicle interior.

In this instance, the one or more panels have a first side and a second side, and the first side and the second side of the panel are flippable. Thus, the panel may be removably installed into the passenger compartment of the motor vehicle with either the first side or the second side visible from the interior of the vehicle. Thereafter, if the consumer desires, the panel may be flipped so that other of the first side or the second side of the panel is visible from the interior of the vehicle.

The door panels and ceiling panels may be secured respectively to the door frame and the ceiling frame by various means that are capable of providing an aesthetically pleasing surface. Thus, it is preferably, that the securing means be hidden (i.e., not be visible) from the interior of the passenger compartment. Furthermore, it is highly desirable that the door panels and the ceiling panels be removably and releasably secured to the door frames and the ceiling frame so that while the panels are in place they are securely fastened and thus do not exhibit any “play” or shifting that would take away from the aesthetic look of the passenger compartment. At the same time, it is also highly desirable that the panels be removable quickly and easily and preferably also without the need for special tools.

It is also contemplated that it may be necessary to initially design or retrofit the passenger compartment of the automobile to provide the necessary securing means so that the various interior components can be removably secured thereto. Thus, if not designed from the factory accordingly, it may be necessary for the consumer to initially have the passenger compartment retrofitted so that it can be modified or customized as described herein.

In addition, depending on the particular year/make/model of the vehicle, at least the door panel(s) may be molded to mate and incorporate features typically found on the interior door panel of the vehicle, including, for example, arm rests, door locks, window mechanisms, storage spaces, interior lights, mirror adjusters, etc. Therefore, it is contemplated that the door panel(s) would fit over these features and that the features would be coupled to or attached to the frame of the door and the door panels would then be secured to the frame of the door to allow access to the features. In addition, if the consumer desires additional or different types of storage to be included in the door panel, the door panel may be designed and molded to incorporate the different types of storage and any other desired features.

It is further contemplated that various securing means may be used for providing the necessary securing means for removably securing the interior components thereto.

In the case of the panels (door panel, interior wall panel, ceiling panel, floor panel, etc.), in one embodiment, the panels are designed to “click” into place without the need for special tools and without the need for high labor costs. It is also very desirable that the securing mechanism is not visible from the interior of the vehicle so as to provide a visually pleasing appearance.

In another embodiment, the securing means may comprise a channel or slot or groove positionable on a first side and a second side of the door panel for receiving the door panel therein. In the case of the ceiling panel(s), one or more channels or slots or grooves may be arranged in the ceiling frame for receiving the one or more ceiling panels therein. In addition, the channel or slot or groove may further comprise a trim edge to “frame” the one or more panels of the door or ceiling.

In still another embodiment, the securing means may comprise a dimple and recess cooperation in which one of the panel (ceiling or door) or the receiving surface (i.e., door frame or ceiling frame) comprises one or more dimples and the other of the panel or receiving surface has one or more recesses that mate with the one or more dimples. This allows the panel(s) to quickly and easily snap into and be released from the door frame or ceiling frame quickly and easily and without the need for special tools.

In still another embodiment, the securing means may comprise a ball and dent system, a dove-tail connection, a J-lock system, a magnetic system, a snap system, a clip system, hook and loop (e.g., Velcro®) and combinations of one or more of the foregoing.

Furthermore, by “removable” it is meant that the securing means does not include any permanent adhesives, glues, locking means or any other “permanent” securing means that would make it difficult (or impossible) to remove the door panel, interior wall panel, ceiling panel, floor panel, etc. from its respective frame without damage to either the panel or the frame, or other parts.

In the case of the floor panels it is further contemplated that the user may wish to switch between “winter” floor panels that are capable of withstanding the salt and grime of winter weather and a “summer” floor panels. In the alternative, as discussed above, a flippable floor panel may be used that incorporates two different looks, thus, allowing the consumer to quickly and easily change the look of the floor of the vehicle.

In another embodiment of the present invention at least one of the seats are removable and replaceable within the vehicle. This may be accomplished by releasably coupling the seat to a pedestal situated for receiving a portion of the underside of the seat. For example, the underside of the seat may have an opening dimensioned for coupling with the pedestal. In the alternative, the underside of the seat may comprise a pedestal that couples with a suitably dimensioned opening attached to an interior floor portion of the vehicle. The seats include, but are not limited to, the driver's seat, front seats of various types and configurations, middle row seats of various types and configurations and rear row seats of various types and configurations and combinations of the foregoing.

In addition, the releasable seat coupling optionally, but preferably, further comprises electrical contacts so that new/replacement seat can be electronically coupled to the automobile in order to provide seat movement as well as heating and cooling of the seat. For example, the consumer may desire to replace at least one of the front seats or the rear seats with seats of a different color, different material, different style or that are more comfortable for the consumer. In the alternative, the consumer may wish to have seats that are more “sporty” for use every day yet be able to switch the seats out for a more formal look for a special occasion. Thus, the invention described herein allows the consumers to quickly and easily swap out seats of their automobile, again without the need for any special tools.

The pedestal is permanently attached to the frame of the vehicle or to the interior floor portion of the vehicle (which is then attached to the frame of the vehicle) and comprises suitable coupling means for coupling the seat to the pedestal. The pedestals receive a portion of the seat and provide electrical connection between the seat and a control mechanism in the pedestal that controls one or more of movement, heating and cooling of the seat when the seat is installed and both mechanically and electrically coupled to the pedestal.

The coupling means for coupling the seat(s) to the car frame may comprise one or more releasably securable “click-in” coupling means. For example, the coupling means may comprise a buckle that buckles the seat to the pedestal or may comprise a depressible button on the pedestal that clicks into a receiving indent or hole in the receiving portion of the seat (or vice versa) or other similar coupling means that allow the pedestal to be coupled to the receiving portion of the seat in a secure but releasably manner to allow the seat to be firmly secured within the automobile yet still be removable as the consumer desires.

In the alternative, instead of removing the seat substructure, or portions thereof, the seat can be designed such that the cushions and panels of the seat are easily removable and replaceable. In this embodiment, the bottom cushion (ie. seating surface) as well as the back cushion (ie. the cushion upon which the occupant's back rests) are removable and easily replaced with cushions of a different appearance or function. Thus the mechanics of the seat remain in the automobile, but the look and feel of the seat can be changed readily.

The method described herein allows the consumer to quickly and easily change the aesthetic look of the passenger compartment of the automobile, including the floor, the door panels, the ceilings, the seats, etc. to provide a completely new look. Furthermore, if a consumer is looking to sell the vehicle, the invention described herein provides a relatively easy means for updating various aspects of the interior of the vehicle to make it more appealing to a potential buyer.

It should also be understood that the following claims are intended to cover all of the generic and specific features of the invention described herein and all statements of the scope of the invention that as a matter of language might fall there between.

What it claimed is:

1. A method of designing or retrofitting a passenger compartment of a motor vehicle, the method comprising the steps of:
a) selecting interior components for removably installing in the passenger compartment of the motor vehicle;
b) removing then currently installed interior components from the passenger compartment of the motor vehicle; and
c) removably installing alternate interior components into the passenger compartment of the motor vehicle;
whereby an aesthetical look of the passenger compartment of the motor vehicle is changed or enhanced.

2. The method according to claim 1, further comprising the step of designing alternate interior components for removable installation into the passenger compartment of the motor vehicle.

3. The method according to claim 2, wherein the alternate interior components are selected from the group consisting of panels, seats, and combinations of one or more of the foregoing.

4. The method according to claim 1, wherein the then currently installed interior components are removed through body openings of the motor vehicle.

5. The method according to claim 1, wherein the motor vehicle is an automobile.

6. The method according to claim 3, where the interior components comprises one or more panels selected from door panels, interior wall panels, trim panels, ceiling panels, floor panels, dashboard panel, seat panels and combinations of one or more of the foregoing.

7. The method according to claim 6, wherein the one or more panels are removably secured to a frame of the passenger compartment.

8. The method according to claim 1, wherein steps a) to c) are repeated.

9. The method according to claim 6, wherein the one or more panels have a first side and a second side,
wherein the first side and the second side are flippable such that either the first side or the second side of the panel may be visible from the passenger compartment of the vehicle, and
wherein the panel may be removably installed into the passenger compartment of the motor vehicle with either the first side or the second side visible from the passenger compartment of the vehicle and wherein attachment means on the panel for holding the panel in the passenger compartment correspondingly mate with attachment means in the passenger compartment regardless of which side of the panel is visible in the passenger compartment.

10. The method according to claim 3, wherein the interior components comprise one or more seats.

11. The method according to claim 10, wherein the one or more seats are mechanically and electrically coupled to a floor of the passenger compartment of the vehicle.

12. The method according to claim 11, wherein an underside of the seat comprises an opening dimensioned for receiving a pedestal therein and wherein the pedestal is attached to the floor of the passenger compartment of the vehicle, wherein the pedestal couples the seat to the passenger compartment of the vehicle and provides electrical contact for providing at least one of movement, heating and cooling of the seat.

13. The method according to claim 12, wherein the pedestal is releasably secured within the opening in the underside of the seat.

14. A method according to claim 1 wherein the interior components are removably installed in the passenger compartment using a removable attachment means selected from the group consisting of snaps, rubber grommets and corresponding male attachments, VELCRO®, magnetic attachment means, corresponding grooves or channels, J-lock system, or temporary adhesive.

15. A method of designing or retrofitting a passenger compartment of a motor vehicle, the method comprising the steps of:
a) designing the passenger compartment of the motor vehicle such that it comprises removably installed interior components;
b) removing then currently installed interior components from the passenger compartment of the motor vehicle; and
c) removably installing alternate interior components into the passenger compartment of the motor vehicle;
whereby an aesthetical look of the passenger compartment of the motor vehicle is changed or enhanced.

16. A method according to claim 15 wherein the interior components are removably installed in the passenger compartment using a removable attachment means selected from the group consisting of snaps, rubber grommets and corresponding male attachments, VELCRO®, magnetic attachment means, corresponding grooves or channels, J-lock system, or temporary adhesive.

17. The method according to claim 16, where the interior components comprises one or more panels selected from door panels, interior wall panels, trim panels, ceiling panels, floor panels, dashboard panel, seat panels and combinations of one or more of the foregoing.
